(19) United States
(12) Patent Application Publication
(10) Pub. No.: US 2025/0284003 A1
(43) Pub. Date: Sep. 11, 2025

(54) OBJECT DETECTION APPARATUS AND METHOD OF DETECTING OBJECT

(71) Applicant: Panasonic Automotive Systems Co., Ltd., Kanagawa (JP)

(72) Inventors: Hiroki YAMASHITA, Kanagawa (JP); Shingo KAWAHARA, Kanagawa (JP)

(21) Appl. No.: 19/070,049

(22) Filed: Mar. 4, 2025

(30) Foreign Application Priority Data
Mar. 8, 2024 (JP) 2024-035980

(51) Int. Cl. G01S 15/931

(52) U.S. Cl. CPC G01S 15/931

(57) ABSTRACT

An object detection apparatus according to an aspect of the present disclosure includes a first sensor which, in operation, measures a distance to an object using an ultrasonic wave in a first period, the first sensor being configured to be provided on a vehicle, a second sensor which, in operation, measures the distance to the object using the ultrasonic wave in a second period after the first period, the second sensor being configured to be provided on the vehicle, and a control circuitry which, in operation, sets a noise monitoring period by the second sensor between the first period and the second period, and when noise is detected in the noise monitoring period, sets a next second period after a next noise monitoring period and a wait period.

### TECHNICAL FIELD

The present disclosure relates to an object detection apparatus and a method of detecting an object.

### BACKGROUND ART

Object detection apparatuses that detect an object present around a vehicle using a distance measurement sensor such as an ultrasonic sensor configured to be mounted on the vehicle are known.

The object detection apparatus detects the presence or absence of an object around a vehicle by causing a distance measurement sensor to transmit an ultrasonic wave after monitoring noise for a predetermined time. For example, in a case where the distance measurement sensor has detected no noise during the noise monitoring, the object detection apparatus detects the position of the object from the time required until reception of the reflected wave of the ultrasonic wave after the ultrasonic wave is transmitted by the distance measurement sensor and reflected by the object. Further, for example, in a case where the distance measurement sensor has detected no noise during the noise monitoring and has received no reflected wave from an object, the object detection apparatus detects that no object is present around the vehicle. Further, for example, in a case where the distance measurement sensor has detected noise during the noise monitoring, the object detection apparatus invalidates the detection result and skips the detection of the object in order to prevent erroneous detection of the object due to interference with noise.

PTL 1 discloses that, in a case where an obstacle is detected using two ultrasonic sensors, the detection results of both ultrasonic sensors are invalidated because if one of the sensors has detected noise, there is a possibility of noise interference also at the other sensor.

### CITATION LIST

### Patent Literature

### PTL 1

Japanese Patent No. 6089585

### SUMMARY OF INVENTION

### Technical Problem

However, in the above-described related art, the reflection wave of the previously transmitted ultrasonic wave may possibly be erroneously detected as noise depending on the transmission period of the ultrasonic wave. In this case, the detection result is invalidated even though no noise is detected, and if such an erroneous detection frequently occurs, the detection frequency of the object may decrease, leading to a deterioration in the object detection performance.

In view of the above circumstances, an object of the present disclosure is to provide an object detection apparatus and a method of detecting an object capable of preventing a deterioration in the detection performance of an object.

### Solution to Problem

An object detection apparatus according to the present disclosure includes: a first sensor which, in operation, measures a distance to an object using an ultrasonic wave in a first period, the first sensor being configured to be provided on a vehicle; a second sensor which, in operation, measures the distance to the object using the ultrasonic wave in a second period after the first period, the second sensor being configured to be provided on the vehicle; and a control circuitry which, in operation, sets a noise monitoring period by the second sensor between the first period and the second period, and when noise is detected in the noise monitoring period, sets a next second period after a next noise monitoring period and a wait period.

An object detection apparatus according to the present disclosure includes: a first sensor which, in operation, measures a distance to an object using an ultrasonic wave in a first period, the first sensor being configured to be provided on a vehicle; a second sensor which, in operation, measures the distance to the object using the ultrasonic wave in a second period after the first period, the second sensor being configured to be provided on the vehicle; and a control circuitry which, in operation, sets a noise monitoring period by the second sensor between the first period and the second period, and when noise exceeding a first threshold is detected in the noise monitoring period, sets a next noise monitoring period using a second threshold between the next first period and the next second period, the second threshold being larger than the first threshold.

A method of detecting an object according to the present disclosure includes: measuring a distance to an object using an ultrasonic wave in a first period by a first sensor configured to be provided on a vehicle; performing noise monitoring using the ultrasonic wave in a noise monitoring period after the first period by a second sensor configured to be provided on the vehicle; measuring the distance to the object using the ultrasonic wave in a second period after the noise monitoring period by the second sensor; and setting, when noise is detected in the noise monitoring period, a next second period after a next noise monitoring period and a wait period.

A method of detecting an object according to the present disclosure includes: measuring a distance to an object using an ultrasonic wave in a first period by a first sensor configured to be provided on a vehicle; performing noise monitoring using the ultrasonic wave in a noise monitoring period after the first period by a second sensor configured to be provided on the vehicle; measuring the distance to the object using the ultrasonic wave in a second period after the noise monitoring period by the second sensor, and setting, when noise exceeding a first threshold is detected in the noise monitoring period, a next noise monitoring period using a second threshold between the next first period and the next second period, the second threshold being larger than the first threshold.

### Advantageous Effects of Invention

According to the present disclosure, it is possible to provide an object detection apparatus and a method of detecting an object capable of preventing a deterioration in the detection performance of an object.

### BRIEF DESCRIPTION OF DRAWINGS

FIG. 1 is a schematic diagram illustrating an example of a vehicle to which an object detection apparatus of the present embodiment is applied;

FIG. 2 is a block diagram illustrating an example of a functional configuration of the object detection apparatus (vehicle) according to the present embodiment;

FIG. 3 is a block diagram illustrating an example of a detailed configuration of a distance measurement sensor according to the present embodiment;

FIG. 4 is a block diagram illustrating an example of a hardware configuration of a control apparatus according to the present embodiment;

FIG. 5 is a diagram illustrating an example of control of the transmission order of ultrasonic waves of the distance measurement sensor by the wave transmission controller in the present embodiment;

FIG. 6 is a diagram illustrating an example of a relationship between transmission and reception of the distance measurement sensor when performing the transmission control illustrated in FIG. 5;

FIG. 7 is a diagram illustrating an example of control of the transmission timing of ultrasonic waves of the distance measurement sensor by the wave transmission controller in the present embodiment;

FIG. 8 is a diagram schematically illustrating an example of a situation in which erroneous noise detection illustrated in FIG. 7 occurs;

FIG. 9 is a diagram illustrating a voltage value of a reflected wave received by the distance measurement sensor when wait control of the distance measurement sensor is performed by the wave transmission controller in the present embodiment;

FIG. 10 is a flowchart illustrating an example of an object detection processing performed by the object detection apparatus according to the present embodiment; and

FIG. 11 is a diagram illustrating an example of control of the transmission timing and the threshold of the ultrasonic wave of the distance measurement sensor by a wave transmission controller in Modification Example 2.

### DESCRIPTION OF EMBODIMENTS

Hereinafter, embodiments of the present disclosure (hereinafter, simply referred to as “the present embodiment”) will be described in detail with reference to the drawings. Note that the present disclosure is not limited to the following embodiments. Further, the following embodiments and modification examples can be combined as appropriate.

First, an appearance configuration of a vehicle to which the object detection apparatus of the present embodiment is applied will be described.

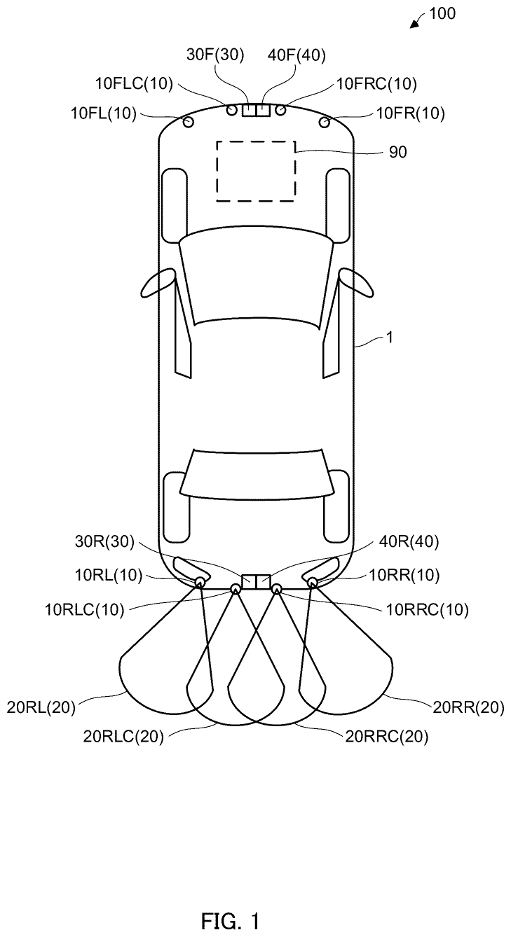

FIG. 1 is a schematic diagram illustrating an example of vehicle 1 to which object detection apparatus 100 of the present embodiment is applied. As illustrated in FIG. 1, vehicle 1 includes a plurality of distance measurement sensors 10, a plurality of imaging apparatuses 30, a plurality of radars 40, and control apparatus 90. Object detection apparatus 100 detects an object present around vehicle 1 using distance measurement sensor 10, and includes at least distance measurement sensor 10 and control apparatus 90. In the present embodiment, a case where object detection apparatus 100 is applied to vehicle 1 will be described as an example, but this is not limitative.

Distance measurement sensor 10 is a sensor that is provided in vehicle 1 to detect an object present around vehicle 1. In the present embodiment, distance measurement sensor 10 detects the presence or absence of an object at a relatively short distance, which is a detection distance of several centimeters to several meters, and the distance to the object, for example. In the present embodiment, a case where distance measurement sensor 10 is an ultrasonic sensor that performs ultrasonic distance measurement for detecting an object will be described as an example, but this is not limitative. The ultrasonic sensor has a transmission function of transmitting an ultrasonic wave of 20 kHz to 100 kHz as a transmission wave, and a reception function of receiving an ultrasonic wave reflected by an object as a reflection wave, for example.

In the present embodiment, vehicle 1 includes, as distance measurement sensor 10, distance measurement sensor 10RL, distance measurement sensor 10RLC, distance measurement sensor 10RRC, distance measurement sensor 10RR, distance measurement sensor 10FL, distance measurement sensor 10FLC, distance measurement sensor 10FRC, and distance measurement sensor 10FR. These distance measurement sensors 10 are provided at different locations in vehicle 1. Further, the detection range of each distance measurement sensor 10 is adjusted such that the detection ranges do not overlap each other at least partially.

Distance measurement sensor 10RL, distance measurement sensor 10RLC, distance measurement sensor 10RRC, and distance measurement sensor 10RR are provided in the rear portion of vehicle 1. Distance measurement sensor 10RL is provided at the left-side corner portion of the rear portion of vehicle 1. Distance measurement sensor 10RLC is provided at the center left side of the rear portion of vehicle 1. Distance measurement sensor 10RRC is provided at the center right side of the rear portion of vehicle 1. Distance measurement sensor 10RR is provided at the right-side corner portion of the rear portion of vehicle 1.

Detection range 20RL of distance measurement sensor 10RL, detection range 20RLC of distance measurement sensor 10RLC, detection range 20RRC of distance measurement sensor 10RRC, and detection range 20RR of distance measurement sensor 10RR are disposed such that the detection ranges do not overlap each other at least partially. Each detection range 20 of the plurality of distance measurement sensors 10 in the rear portion may be disposed such that the detection ranges partially overlap each other.

Distance measurement sensor 10FL, distance measurement sensor 10FLC, distance measurement sensor 10FRC, and distance measurement sensor 10FR are provided at the front portion of vehicle 1. Distance measurement sensor 10FL is provided at the left corner portion of the front portion of vehicle 1. Distance measurement sensor 10FLC is provided at the center left side of the front portion of vehicle 1. Distance measurement sensor 10FRC is provided at the center right of the front portion of vehicle 1. Distance measurement sensor 10FR is provided at the right-side corner portion of the front portion of vehicle 1.

The detection range of distance measurement sensor 10FL, the detection range of distance measurement sensor 10FLC, the detection range of distance measurement sensor 10FRC, and the detection range of distance measurement sensor 10FR are disposed such that the detection ranges do not overlap each other at least partially as with the rear portion (not illustrated). Each detection range of the plurality of distance measurement sensors 10 in the front portion may also be disposed such that the detection ranges partially overlap each other as with the rear portion.

Note that, the number and arrangement of distance measurement sensors 10 provided in vehicle 1 are not limited to the above-described embodiment. For example, one or more distance measurement sensors 10 may be provided on the side portion of vehicle 1.

Imaging apparatus 30 captures the periphery of vehicle 1 and obtains a captured image. Imaging apparatus 30 outputs the acquired captured image to control apparatus 90.

In the present embodiment, vehicle 1 includes imaging apparatus 30F and imaging apparatus 30R as imaging apparatus 30. Imaging apparatus 30F is provided at the front portion of vehicle 1 and obtains a captured image of the front periphery of vehicle 1. Imaging apparatus 30R is provided at the rear portion of vehicle 1 and obtains a captured image of the periphery of the rear of vehicle 1. Note that the number and arrangement of imaging apparatuses 30 provided in vehicle 1 are not limited to the above-described embodiment. Further, in object detection apparatus 100 of the present embodiment, imaging apparatus 30 may be omitted.

Radar 40 detects objects around vehicle 1 and measures the distance to the objects (the distance between the objects and vehicle 1). Radar 40 detects objects around vehicle 1 by scanning, for example, millimeter waves, which are electromagnetic waves.

In the present embodiment, vehicle 1 includes radar 40F and radar 40R as radar 40. Radar 40F is provided at the front portion of vehicle 1, and detects an object around the front of vehicle 1 by scanning the periphery of the front of vehicle 1. Radar 40R is provided at the rear portion of vehicle 1 and detects objects around the rear of vehicle 1 by scanning the periphery of the rear of vehicle 1. Note that the number and arrangement of radars 40 provided in vehicle 1 are not limited to the above-described embodiment. Further, in object detection apparatus 100 of the present embodiment, radar 40 may be omitted.

Next, a functional configuration of the object detection apparatus (vehicle) according to the present embodiment will be described.

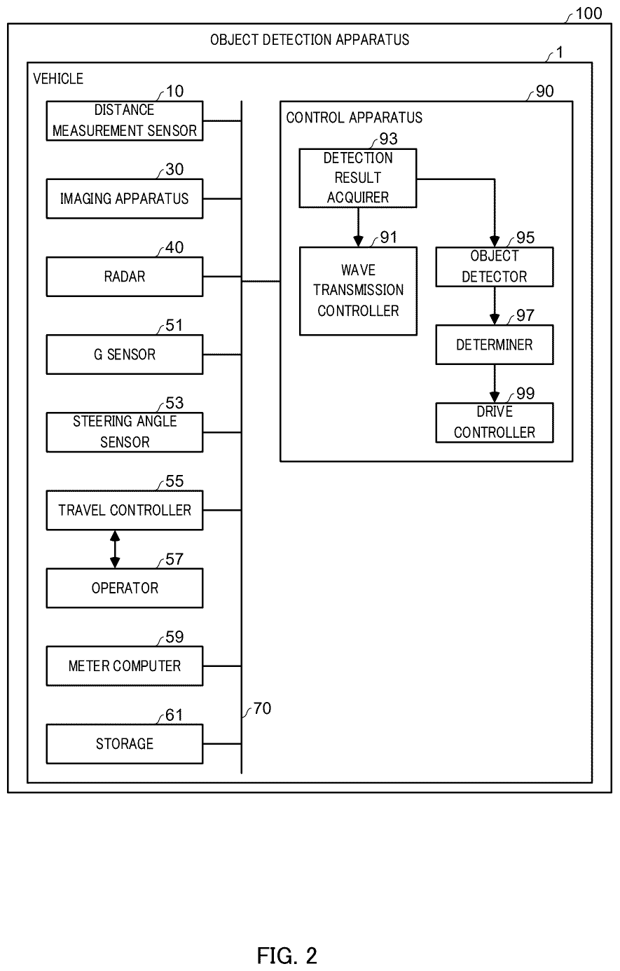

FIG. 2 is a block diagram illustrating an example of a functional configuration of object detection apparatus 100 (vehicle 1) according to the present embodiment. As illustrated in FIG. 2, object detection apparatus 100 (vehicle 1) includes distance measurement sensor 10, imaging apparatus 30, radar 40, G sensor 51, steering angle sensor 53, travel controller 55, operator 57, meter computer 59, storage 61, and control apparatus 90.

Distance measurement sensor 10, imaging apparatus 30, radar 40, G sensor 51, steering angle sensor 53, travel controller 55, meter computer 59, storage 61, and control apparatus 90 are communicably connected to each other via bus 70. Bus 70 may be, for example, a local area network such as a Controller Area Network (CAN), but is not limited thereto.

Distance measurement sensor 10 detects an object within the detection range and outputs the detection result of the object to control apparatus 90. Note that the object is an object that can be detected by distance measurement sensor 10. For example, examples of the object may include an object that generates reflection waves by reflecting the ultrasonic wave transmitted from distance measurement sensor 10.

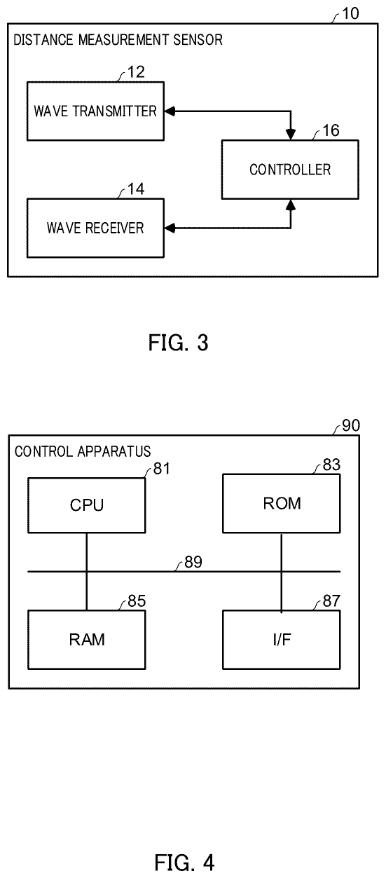

FIG. 3 is a block diagram illustrating an example of a detailed configuration of distance measurement sensor 10 according to the present embodiment. As illustrated in FIG. 3, distance measurement sensor 10 includes wave transmitter 12, wave receiver 14, and controller 16. Each of wave transmitter 12 and wave receiver 14 is communicably connected to controller 16. Further, controller 16 is communicably connected to control apparatus 90.

Wave transmitter 12 transmits an ultrasonic wave. Wave receiver 14 receives a reflection wave that is an ultrasonic wave reflected by an object. Wave transmitter 12 and wave receiver 14 transmit an ultrasonic wave via a piezoelectric element, and receive a reflected wave, for example. Controller 16 controls the transmission timing, transmission period, frequency of the ultrasonic wave, and the like of the ultrasonic wave transmitted from wave transmitter 12 under the instruction from control apparatus 90. Further, controller 16 causes wave receiver 14 to monitor noise before causing wave transmitter 12 to transmit an ultrasonic wave. Further, controller 16 measures the distance to the object (relative position with respect to distance measurement sensor 10) by measuring the time from transmission of the ultrasonic wave at wave transmitter 12 to reception of the reflected wave at wave receiver 14. Controller 16 outputs to control apparatus 90 the detection result including the noise monitoring result (presence or absence of noise), the presence or absence of object detection, and the distance to the object.

Since imaging apparatus 30 and radar 40 have been described with reference to FIG. 1, the description thereof will be omitted.

G sensor 51 measures the vehicle speed and acceleration of vehicle 1 and outputs the measurement results to control apparatus 90.

Steering angle sensor 53 detects the steering angle of a steering wheel provided in vehicle 1 and outputs the steering angle information to control apparatus 90.

Travel controller 55 is an ECU (Engine Control Unit) that controls the travel of vehicle 1. Travel controller 55 is communicably connected to operator 57. Travel controller 55 controls a driving apparatus such as an engine or a motor of vehicle 1 and a transmission apparatus such as a transmission of vehicle 1 in accordance with operation information of a driver (passenger) received from operator 57.

Operator 57 is operated by the driver. Operator 57 includes, for example, an ignition switch, a shift lever, an accelerator pedal, and a brake pedal. Note that, operator 57 is not limited to these.

Travel controller 55 controls the drive apparatus and the transmission system apparatus of vehicle 1 in accordance with operation information of the ignition switch, shift position information of the shift lever, accelerator pedal operation information of the accelerator pedal, brake pedal information of the brake pedal, and the like.

The operation information of the ignition switch is, for example, information representing a power supply instruction to each part of the electrical system of vehicle 1 or an engine start instruction for vehicle 1. Travel controller 55 that has received the power supply instruction to each part of the electrical system of vehicle 1 starts supplying power to the electronic equipment configured to be mounted on vehicle 1. Further, travel controller 55 that has received the instruction to start the engine of vehicle 1 starts the engine of vehicle 1.

The shift position information of the shift lever is information representing the position of the shift lever. The shift position information is information representing a shift position such as parking, reverse, neutral, or drive, for example.

Meter computer 59 includes an information notification function for a passenger such as a driver. The information notification function includes, but not limited to, a display function for displaying information and a sound output function for outputting a sound representing information. Examples of the display function may include a combination meter apparatus that performs notification with a display, for example. Examples of the sound output function may include a sound generation apparatus that performs notification with a buzzer or voice, for example.

Storage 61 stores various data. Storage 61 may be, but not limited to, at least any of a semiconductor memory element such as a random access memory (RAM) or a flash memory, a hard disk, and an optical disk, for example. Storage 61 may be constituted by one or a plurality of storage media.

Control apparatus 90 controls each section included in object detection apparatus 100 (vehicle 1). In the present embodiment, various controls performed by control apparatus 90 will be described, mainly including transmission control of ultrasonic waves for each of the plurality of distance measurement sensors 10 and object detection processing using the detection results of distance measurement sensor 10, but this is not limitative.

FIG. 4 is a block diagram illustrating an example of a hardware configuration of control apparatus 90 according to the present embodiment. As illustrated in FIG. 4, control apparatus 90 includes CPU (Central Processing Unit) 81, ROM (Read Only Memory) 83, RAM 85, I/F 87, and the like, which are connected to each other by bus 89, and has a hardware configuration using an existing computer.

CPU 81 is an arithmetic apparatus that controls control apparatus 90 of the present embodiment. ROM 83 stores programs and the like for implementing various processes by CPU 81. RAM 85 stores data used for various processes by CPU 81. I/F 87 is an interface for transmitting and receiving data.

A program for executing various controls and various processes executed by control apparatus 90 of the present embodiment is incorporated in advance in ROM 83 or the like. Note that the program executed by control apparatus 90 in the present embodiment may be recorded on a computer-readable recording medium such as a CD-ROM, a flexible disk (FD), a CD-R, or a DVD (Digital Versatile Disk) in a file format that is installable or executable on control apparatus 90.

The description will be continued with reference to FIG. 2. As illustrated in FIG. 2, control apparatus 90 includes wave transmission controller 91, detection result acquirer 93, object detector 95, determiner 97, and drive controller 99. Some or all of each functional section included in control apparatus 90 may be implemented by causing a processing apparatus such as CPU 81 to execute a program, by software, by hardware such as an integrated circuit (IC), or by a combination of software and hardware, for example. Note that at least some of functional sections included in control apparatus 90 may be mounted on an external information processing apparatus that is communicably connected to control apparatus 90 via a network or the like.

Wave transmission controller 91 controls the transmission of an ultrasonic wave of each of the plurality of distance measurement sensors 10. Hereinafter, the control of transmission of distance measurement sensor 10 by wave transmission controller 91 in the present embodiment will be described using distance measurement sensor 10RL, distance measurement sensor 10RLC, distance measurement sensor 10RRC, and distance measurement sensor 10RR provided in the rear portion of vehicle 1 as examples. Note that the method described below is not limited to the above and can also be applied to distance measurement sensor 10 provided in the front portion of vehicle 1.

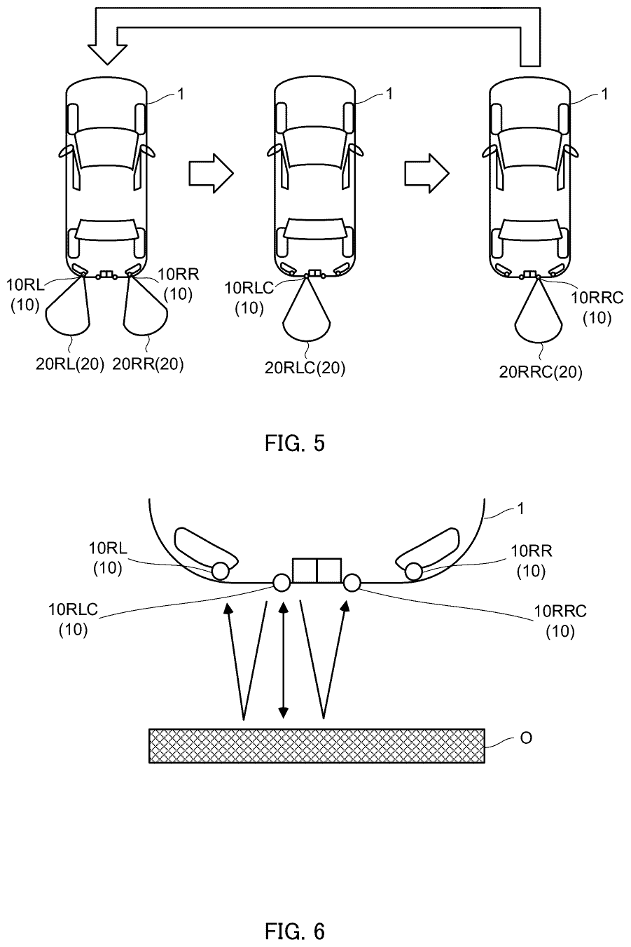

FIG. 5 is a diagram illustrating an example of control of the transmission order of the ultrasonic wave at distance measurement sensor 10 by wave transmission controller 91 in the present embodiment. In a case where ultrasonic waves are transmitted simultaneously from the plurality of distance measurement sensors 10, the distance measurement accuracy may decrease because even if the reflected waves are received, the reflected waves of the ultrasonic waves from distance measurement sensors 10 as transmission sources may not be distinguished. For this reason, in the present embodiment, wave transmission controller 91 causes each of the plurality of distance measurement sensors 10 to sequentially transmit ultrasonic waves in accordance with a predetermined transmission order. For example, as illustrated in FIG. 5, control apparatus 90 causes each of distance measurement sensors 10 to sequentially transmit ultrasonic waves in a cycle of distance measurement sensors 10RL and 10RR, distance measurement sensor 10RLC, and distance measurement sensor 10RRC in a periodic manner. Note that, since distance measurement sensors 10RL and 10RR are provided at respective corner portions at both end portions of vehicle 1 and as such the influence of interference is small, the distance measurement accuracy is less likely to decrease even when the ultrasonic waves are transmitted simultaneously. For this reason, in the present embodiment, wave transmission controller 91 causes distance measurement sensors 10RL and 10RR to simultaneously transmit ultrasonic waves.

FIG. 6 is a diagram illustrating an example of a relationship between transmission and reception of distance measurement sensor 10 when performing the transmission control according to FIG. 5. FIG. 6 illustrates an example situation in which ultrasonic waves are transmitted by distance measurement sensor 10RLC and reflected by object O by hitting object O. In this situation, in addition to distance measurement sensor 10RLC, distance measurement sensor 10RL and distance measurement sensor 10RRC, which are disposed adjacent to distance measurement sensor 10RLC, also receive the reflected wave. In this manner, in the present embodiment, the detection performance of the object is improved by increasing the detection frequency of an object by causing not only distance measurement sensor 10 that has transmitted the ultrasonic wave, but also distance measurement sensor 10 capable of receiving that reflection wave of the ultrasonic wave to receive the reflection wave of the ultrasonic wave.

Note that, although not illustrated, when distance measurement sensors 10RL and 10RR transmit ultrasonic waves, distance measurement sensors 10RLC and 10RRC, which are adjacently disposed, also receive the reflected waves, for example. Further, when distance measurement sensor 10RRC transmits an ultrasonic wave, not only distance measurement sensor 10RRC, but also distance measurement sensor 10RLC and distance measurement sensor 10RR, which are adjacently disposed, receive the reflected wave, for example.

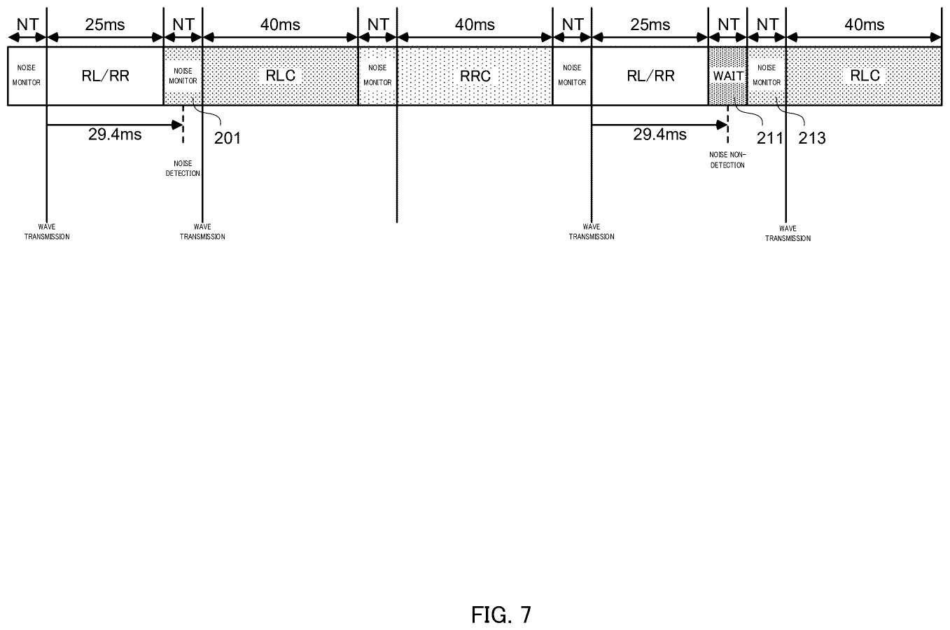

FIG. 7 is a diagram illustrating an example of control of the transmission timing of the ultrasonic wave of distance measurement sensor 10 by wave transmission controller 91 in the present embodiment. In the example illustrated in FIG. 7, wave transmission controller 91 causes each distance measurement sensor 10 to transmit ultrasonic waves in the order of distance measurement sensors 10RL and 10RR, distance measurement sensor 10RLC, distance measurement sensor 10RRC, distance measurement sensors 10RL and 10RR . . . as described in FIG. 5.

Further, in the example illustrated in FIG. 7, the noise monitoring time performed before the transmission of the ultrasonic wave is set to NT for each distance measurement sensor 10 by wave transmission controller 91, and the reception time is set to 25 ms for distance measurement sensors 10RL and 10RR and to 40 ms for distance measurement sensors 10RLC and 10RRC.

Note that, the example illustrated in FIG. 7 assumes that distance measurement sensors 10RL and 10RR detect objects located within approximately 3.5 m in the traveling direction (backward direction). Here, the time required for detecting an object located 3.5 m ahead is approximately 20.6 ms according to Equation 1. Hereinafter, the velocity of the ultrasonic wave is set to 340 m/s.

$$( 3500 mm / 340 m / s ) \times 2 \approx 20.6 ms \qquad ( Equation 1 )$$

Similarly, the example illustrated in FIG. 7 assumes that distance measurement sensors 10RLC and 10RRC detect objects located within approximately 6 m in the traveling direction (backward direction). Here, the time required for detecting an object located 6 m ahead is approximately 35.3 ms according to Equation 2.

$$( 6000 mm / 340 m / s ) \times 2 \approx 35.3 ms \qquad ( Equation 2 )$$

As described above, the reception time is calculated to be approximately 20.6 ms for distance measurement sensors 10RL and 10RR, and to be approximately 35.3 ms for distance measurement sensors 10RLC and 10RRC. On the other hand, in the example illustrated in FIG. 7, the detection period of the object is shortened and the detection frequency is increased by tightly setting the reception time to 25 ms for distance measurement sensors 10RL and 10RR and to 40 ms for distance measurement sensors 10RLC and 10RRC, thus improving the detection performance of the object. Further, in the example illustrated in FIG. 7, the detection period of the object is shortened and the detection frequency is increased also by narrowing the detection range and narrowing the reception time for distance measurement sensors 10RL and 10RR provided at the corner portions of the rear portion of vehicle 1, compared to distance measurement sensors 10RLC and 10RRC.

The noise monitoring time is a time for each distance measurement sensor 10 to monitor noise before the transmission of the ultrasonic wave in order to avoid interference between the transmitted ultrasonic wave and noise. In the noise monitoring time, NT, which is a time common to each distance measurement sensor 10, is set. The NT set as the noise monitoring time can be, for example, any time shorter than the reception time of 25 ms of distance measurement sensors 10RL and 10RR. Examples of the noise may include, but not limited to, construction site noise, abnormal sounds from fluorescent lights, exhaust sounds from motorcycles (motorbikes), and ultrasonic wave transmitted by oncoming vehicles.

The noise monitoring result, which is included in the detection result output by distance measurement sensor 10 to control apparatus 90 as described above, is acquired by detection result acquirer 93. In a case where the noise monitoring result acquired by detection result acquirer 93 indicates “Noise Present,” object detector 95 discards the detection result, invalidates the presence or absence of object detection and the distance to the object, and skips the detection of the object in order to prevent erroneous detection of the object due to interference with noise.

In the present embodiment, as described above, the reception time of distance measurement sensor 10 is tightly set in order to shorten the detection period of the object and increase the detection frequency. For this reason, when noise is monitored during the noise monitoring time, the reflection wave of the ultrasonic wave transmitted one time before may possibly be erroneously detected as noise.

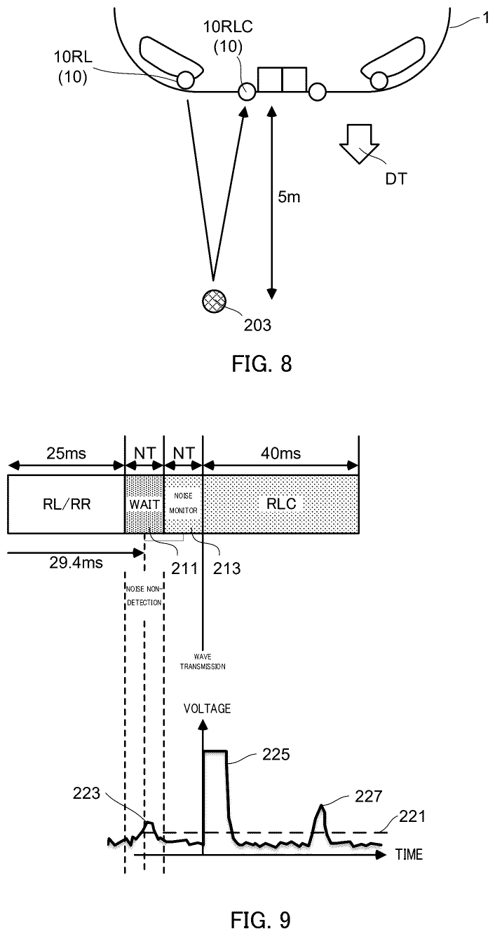

In the example illustrated in FIG. 7, distance measurement sensor 10RLC detects (erroneously detects) the reflection wave of the ultrasonic wave transmitted by distance measurement sensor 10RL one time before as noise in noise monitoring time 201. FIG. 8 is a diagram schematically illustrating an example of a situation in which erroneous noise detection illustrated in FIG. 7 occurs. In the example illustrated in FIG. 8, vehicle 1 is moving (backward) in traveling direction DT, and object 203 is located at a position 5 m away from vehicle 1. In the state illustrated in FIG. 8, the reflected wave of the ultrasonic wave that is transmitted by distance measurement sensor 10RL and reflected by object 203 is detected as noise by distance measurement sensor 10RLC. Note that the time required for detecting an object located 5 m ahead is approximately 29.4 ms according to Equation 3.

$$( 5000 mm / 340 m / s ) \times 2 \approx 29.4 ms \qquad ( Equation 3 )$$

In this manner, in a case where the reception time of distance measurement sensor 10 is tightly set and an object is present at a slightly remote location with respect to the detection target distance, the reflection wave of the ultrasonic wave from the object returns in the noise monitoring time of distance measurement sensor 10 for transmitting the ultrasonic wave next, thus causing erroneous detection. Note that, the detection target distance is 3.5 m for distance measurement sensor 10RL, for example. In this case, the detection result is invalidated even though no noise is detected as described above.

Further, the state in which an object is present at a slightly remote location with respect to the detection target distance is considered to continue for a certain period of time rather than being resolved in a short period of time. For example, the state illustrated in FIG. 8 is not resolved unless the distance to object 203 decreases to approximately 3.5 m, which is the detection target distance for distance measurement sensor 10RL, or unless the distance to object 203 increases to a distance where the reflection wave from object 203 is not detected as noise. As a result, situations in which the detection result is invalidated despite no noise being detected occur frequently, which is undesirable.

In view of this, in the present embodiment, when noise is detected by distance measurement sensor 10RLC (an example of the second sensor), wave transmission controller 91 causes distance measurement sensor 10RLC to monitor noise after waiting the monitoring of noise for a predetermined time after the next distance measurement of distance measurement sensor 10RL (an example of the first sensor).

Hereinafter, wait control for waiting noise monitoring will be described while describing the transmission timing of each distance measurement sensor 10 illustrated in FIG. 7.

First, wave transmission controller 91 sets NT as the noise monitoring time and causes distance measurement sensors 10RL and 10RR to monitor noise during NT. When the noise monitoring time elapses, wave transmission controller 91 sets 25 ms as the reception time for distance measurement sensors 10RL and 10RR, and causes distance measurement sensors 10RL and 10RR to transmit ultrasonic waves and detect the reflected waves received for 25 ms. When the wave reception time elapses, distance measurement sensors 10RL and 10RR output the detection results to control apparatus 90. Note that, since distance measurement sensors 10RL and 10RR have detected no noise, the control performed by control apparatus 90 using the detection result will be omitted.

Subsequently, wave transmission controller 91 sets NT as noise monitoring time 201 and causes distance measurement sensor 10RLC to monitor noise during NT (an example of the first time). Here, as illustrated in FIG. 7, distance measurement sensor 10RLC detects (erroneously detects) the reflection wave of the ultrasonic wave transmitted by distance measurement sensor 10RL one time before as noise in noise monitoring time 201. When noise monitoring time 201 elapses, wave transmission controller 91 sets 40 ms as the reception time of distance measurement sensor 10RLC, and causes distance measurement sensor 10RLC to transmit ultrasonic waves and detect the received reflected wave for 40 ms. When the wave reception time elapses, distance measurement sensor 10RLC outputs the detection result to control apparatus 90, and the detection result is acquired by detection result acquirer 93.

In this case, object detector 95 discards the detection result and invalidates the presence or absence of object detection and the distance to the object because the noise monitoring result included in the detection result acquired by detection result acquirer 93 indicates “Noise Present.”

Further, since the noise monitoring result included in the detection result acquired by detection result acquirer 93 indicates “Noise Present,” wave transmission controller 91 sets a flag for setting a wait time before the next noise monitoring of distance measurement sensor 10RLC. For example, wave transmission controller 91 sets a flag indicating distance measurement sensor 10RLC.

Subsequently, wave transmission controller 91 confirms whether the flag indicates distance measurement sensor 10 as the next control target, but since the next control target is distance measurement sensor 10RRC, normal control is performed. Wave transmission controller 91 sets NT as the noise monitoring time and causes distance measurement sensor 10RRC to monitor noise during NT. When the noise monitoring time elapses, wave transmission controller 91 sets the reception time of distance measurement sensor 10RRC to 40 ms, and causes distance measurement sensor 10RRC to transmit the ultrasonic wave and detect the received reflected wave for 40 ms. When the wave reception time elapses, distance measurement sensor 10RRC outputs the detection result to control apparatus 90. Note that, since distance measurement sensor 10RRC has detected no noise, the control performed by control apparatus 90 using the detection result will be omitted.

Subsequently, wave transmission controller 91 confirms whether the flag indicates distance measurement sensor 10 as the next control target, but since the next control targets are distance measurement sensors 10RL and 10RR, normal control is performed. Wave transmission controller 91 sets NT as the noise monitoring time and causes distance measurement sensors 10RL and 10RR to monitor noise during NT. When the noise monitoring time elapses, wave transmission controller 91 sets 25 ms as the reception time for distance measurement sensors 10RL and 10RR, and causes distance measurement sensors 10RL and 10RR to transmit ultrasonic waves and detect the reflected waves received for 25 ms. When the wave reception time elapses, distance measurement sensors 10RL and 10RR output the detection results to control apparatus 90. Note that, since distance measurement sensors 10RL and 10RR have detected no noise, the control performed by control apparatus 90 using the detection result will be omitted.

Subsequently, wave transmission controller 91 confirms whether the flag indicates distance measurement sensor 10 as the next control target, but since the control target is distance measurement sensor 10RLC indicated by the flag, the flag is initialized to perform wait control. FIG. 9 is a diagram illustrating a voltage value of a reflected wave received by distance measurement sensor 10RLC when wait control of distance measurement sensor 10RLC is performed by wave transmission controller 91 in the present embodiment.

Wave transmission controller 91 sets NT as WAIT time 211 and causes distance measurement sensor 10RLC to wait for noise monitoring during NT. It is assumed here that the state in which the reflection wave of the ultrasonic wave transmitted by distance measurement sensor 10RL returns as noise has not been resolved as in the previous time. However, since distance measurement sensor 10RLC does not monitor noise during WAIT time 211, even when reflection wave 223 having a voltage value exceeding threshold 221 is received, it is not detected as noise as illustrated in FIG. 9.

Subsequently, wave transmission controller 91 sets NT as noise monitoring time 213 and causes distance measurement sensor 10RLC to monitor noise during NT. As illustrated in FIG. 9, distance measurement sensor 10RLC does not receive a reflected wave having a voltage value exceeding threshold 221 during noise monitoring time 213, and therefore does not detect noise. When noise monitoring time 213 elapses, wave transmission controller 91 sets 40 ms as the reception time of distance measurement sensor 10RLC, and causes distance measurement sensor 10RLC to transmit ultrasonic waves and detect the received reflected wave for 40 ms. As illustrated in FIG. 9, distance measurement sensor 10RLC transmits ultrasonic wave 225 and receives reflection wave 227 with a voltage value exceeding threshold 221 within the reception time. Note that reflection wave 227 is a reflection wave of ultrasonic wave 225 reflected by an object. When the wave reception time elapses, distance measurement sensor 10RLC outputs the detection result to control apparatus 90. Note that, since distance measurement sensor 10RLC has detected no noise due to the wait control, the control performed by control apparatus 90 using the detection result will be omitted.

Returning to FIG. 2, other functional sections included in control apparatus 90 will be described.

Detection result acquirer 93 acquires the detection result output from distance measurement sensor 10. The detection result includes the noise monitoring result (presence or absence of noise), presence or absence of object detection, and the distance to the object as described above.

In a case where the detection result acquired by detection result acquirer 93 indicates “No Noise” and “Object Present,” object detector 95 detects the relative position to the object from the distance to the object. In a case where the detection result acquired by detection result acquirer 93 indicates “No Noise” and “No Object”, object detector 95 detects that no object is present around vehicle 1. In a case where the detection result acquired by detection result acquirer 93 indicates “Noise Present,” object detector 95 discards the detection result, invalidates the presence or absence of object detection and the distance to the object, and skips the detection of the object in order to prevent erroneous detection of the object due to interference with noise.

In a case where the same object is detected a predetermined number of times by any of the plurality of distance measurement sensors 10, determiner 97 determines that the same object is an object present around vehicle 1.

For example, if object detector 95 detects an object 5 m ahead based on the previous detection result of distance measurement sensor 10RLC, and detects an object 4.8 m ahead based on the latest detection result of distance measurement sensor 10RLC. In this case, determiner 97 compares the displacement amount of the object detected by distance measurement sensor 10RLC with the movement amount of vehicle 1 for the vehicle speed, and if both values match, determiner 97 determines that the tracking is established and increments the confidence level. Hereinafter, each time the position of an object is detected from the detection result of distance measurement sensor 10RLC by object detector 95, determiner 97 performs the above-described processing, and when the confidence level reaches the upper limit value (for example, 3), determiner 97 determines that the tracked object is an object present around vehicle 1. Note that, in a case where the detection of the object is skipped due to “Noise Present” by object detector 95, determiner 97 may also skip the determination process while maintaining the confidence level.

Drive controller 99 drives vehicle 1 based on the determination result of determiner 97. For example, drive controller 99 controls travel controller 55 to avoid contact with the object determined by determiner 97. Further, for example, drive controller 99 controls travel controller 55 to travel while avoiding contact with the object determined by determiner 97. Further, for example, drive controller 99 controls travel controller 55 to stop in order to avoid contact with the object determined by determiner 97.

Further, drive controller 99 may output information on the object determined by determiner 97 to meter computer 59. For example, drive controller 99 may cause meter computer 59 to display or output information indicating that the determined object is located around vehicle 1.

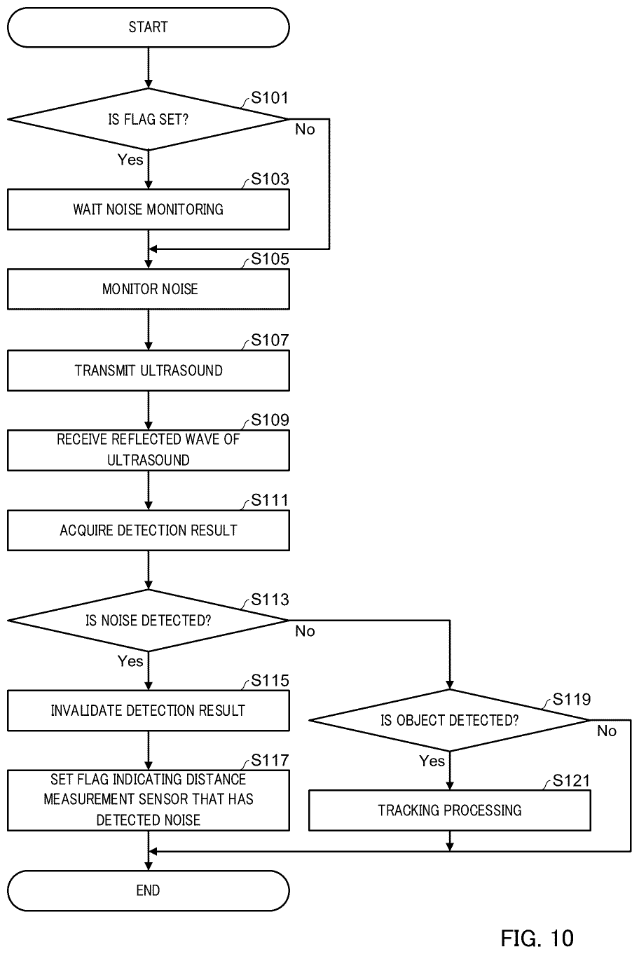

FIG. 10 is a flowchart illustrating an example of an object detection processing performed by object detection apparatus 100 of the present embodiment.

First, wave transmission controller 91 confirms whether a flag indicating distance measurement sensor 10 as the next control target is set (step S101).

In a case where a flag indicating distance measurement sensor 10 as the next control target is set (Yes in step S101), wave transmission controller 91 sets NT as the WAIT time and causes distance measurement sensor 10 to wait for noise monitoring during NT (step S103). In a case where a flag indicating distance measurement sensor 10 as the next control target is not set (No in step S101), the processing in step S103 is not performed.

Subsequently, wave transmission controller 91 sets NT as the noise monitoring time and causes distance measurement sensor 10 to monitor noise during NT (step S105).

When the noise monitoring time elapses, wave transmission controller 91 sets the reception time of distance measurement sensor 10, and causes distance measurement sensor 10 to transmit the ultrasonic wave (step S107) and detect the reflected wave received during the reception time (step S109).

When the wave reception time elapses, distance measurement sensor 10 outputs the detection result to control apparatus 90, and detection result acquirer 93 acquires the detection result (step S111).

In a case where the detection result indicates “Noise Present” (Yes in step S113), object detector 95 discards the detection result, invalidates the presence or absence of object detection and the distance to the object, and skips the detection of the object (step S115).

Subsequently, wave transmission controller 91 sets a flag indicating distance measurement sensor 10 in order to set a wait time before the next noise monitoring of distance measurement sensor 10 that has detected noise (step S117).

In a case where the detection result indicates “No Noise” and “Object Detected” (No in step S113, Yes in step S119), determiner 97 performs tracking processing of the object whose position is detected from the detection result of distance measurement sensor 10 by object detector 95 (step S121). In a case where the detection result indicates “No Object Detected” (No in step S119), the processing in step S121 is not performed.

In this manner, in the present embodiment, when noise is detected by distance measurement sensor 10RLC, wave transmission controller 91 causes distance measurement sensor 10RLC to monitor the noise after waiting the monitoring of noise for a predetermined time after the next distance measurement of distance measurement sensor 10RL. For this reason, in the case where the noise is a reflection wave of the ultrasonic wave transmitted one time before, distance measurement sensor 10RLC receives the reflected wave during the wait time, and thus, the noise is not detected as noise, erroneous detection can be prevented, and the detection result is not invalidated.

According to the present embodiment, it is thus possible to prevent the noise from being erroneously detected as noise in the second and subsequent cases in the case where the noise is a reflection wave of the ultrasonic wave transmitted one time before. According to the present embodiment, it is thus possible to avoid a situation in which the detection result is invalidated despite the fact that no noise is detected, and it is possible to suppress the deterioration of the detection performance of an object.

Further, according to the present embodiment, since the wait time is the same as the noise monitoring time, it is possible to prevent the reflection wave of the ultrasonic wave transmitted one time before from being erroneously detected as noise with simple control.

Note that, according to the present embodiment, wave transmission controller 91 causes distance measurement sensor 10RLC to monitor noise after waiting the monitoring of noise for a predetermined time, and thus, even if the noise is not a reflection wave of the ultrasonic wave transmitted one time before but is noise such as a sound, the noise can be correctly detected as noise, thus preventing erroneous detection of an object due to interference with the noise.

### Modification Example 1

In the above-described embodiment, the WAIT time is a fixed time equal to the noise monitoring time as an example, but this is not limitative. In Modification Example 1, an example in which the WAIT time is varied within the range of the noise monitoring time will be described.

In a case where distance measurement sensor 10 detects noise during the noise monitoring time, distance measurement sensor 10 identifies the noise detection time required from the start of the noise monitoring time to the detection of the noise, and includes the noise detection time in the detection result. Further, in a case where the noise monitoring result included in the detection result indicates “Noise Present,” wave transmission controller 91 sets a flag indicating distance measurement sensor 10 that has detected the noise, and associates the noise detection time included in the detection result. When the next control target is distance measurement sensor 10 indicated by the flag, wave transmission controller 91 sets the noise detection time as the WAIT time and causes distance measurement sensor 10RLC to wait for noise monitoring during the noise detection time.

In this manner, in Modification Example 1, the WAIT time is set as a variable time until noise is actually detected, and thus, the WAIT time can be shortened and the detection period of the object can be shortened to increase the detection frequency compared to a case where the noise monitoring time is used as the WAIT time. Note that, the WAIT time may be set to a time equal to or longer than the noise detection time and equal to or shorter than the noise monitoring time.

Further, the time at which the noise is detected may be, for example, the time at which the voltage value exceeds the threshold. Further, in a case where three points, for example, a portion where the voltage value exceeds the threshold, the peak of the voltage value, and a portion where the voltage value falls below the threshold, are detected, the time at which noise is detected may be set as the time at the moment of the peak of the voltage value.

### Modification Example 2

In the above-described embodiment and Modification Example 1, a WAIT time is provided to avoid detecting the reflection wave of the ultrasonic wave transmitted one time before as noise as an example, but this is not limitative. In Modification Example 2, as an example, the threshold of the reflection intensity for noise monitoring is changed without providing a WAIT time so as to avoid detection of the reflection wave of the ultrasonic wave transmitted one time before as noise.

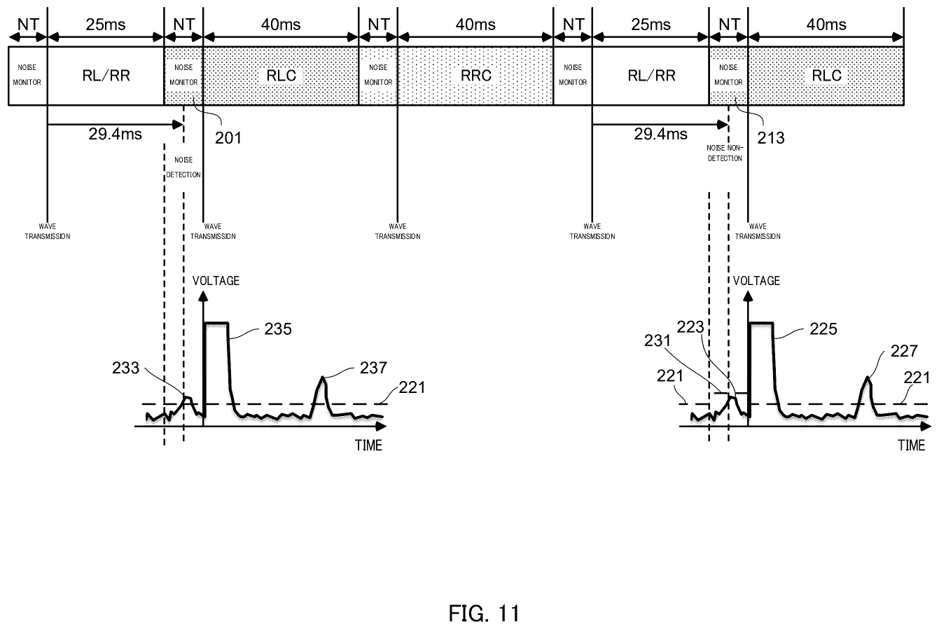

FIG. 11 is a diagram illustrating an example of control of the transmission timing and the threshold of the ultrasonic wave of distance measurement sensor 10 by wave transmission controller 91 in Modification Example 2. Note that, the transmission timing of the ultrasonic wave illustrated in FIG. 11 is the same as the transmission timing of the ultrasonic wave illustrated in FIG. 7 except that the WAIT time is not provided, and as such noise monitoring by distance measurement sensor 10RLC will be described here.

First, control in noise monitoring time 201 will be described. Wave transmission controller 91 sets NT as noise monitoring time 201 and causes distance measurement sensor 10RLC to monitor noise during NT (an example of the first time). Here, as illustrated in FIG. 11, distance measurement sensor 10RLC receives reflection wave 233 of the ultrasonic wave transmitted by distance measurement sensor 10RL one time before in noise monitoring time 201, and detects (erroneously detects) reflection wave 233 as noise because the voltage value of reflection wave 233 exceeds threshold 221.

Next, control in noise monitoring time 213 will be described. Wave transmission controller 91 confirms whether the flag indicates distance measurement sensor 10 as the next control target, but since the control target is distance measurement sensor 10RLC indicated by the flag, the flag is initialized to perform threshold control.

As illustrated in FIG. 11, wave transmission controller 91 causes distance measurement sensor 10RLC to change the threshold 221 to threshold 231, which is larger than threshold 221. Further, wave transmission controller 91 sets NT as noise monitoring time 213 and causes distance measurement sensor 10RLC to monitor noise during NT. It is assumed here that the state in which the reflection wave of the ultrasonic wave transmitted by distance measurement sensor 10RL returns as noise has not been resolved as in the previous time. Distance measurement sensor 10RLC receives reflected wave 223 in noise monitoring time 213, but does not detect reflected wave 223 as noise because threshold 221 has been changed to threshold 231 and reflected wave 223 does not have a voltage value exceeding threshold 231. When noise monitoring time 213 elapses, wave transmission controller 91 causes distance measurement sensor 10RLC to reset threshold 231 to threshold 221.

In this manner, in Modification Example 2, detection of the reflection wave of the ultrasonic wave transmitted one time before as noise is avoided by the threshold control without providing the WAIT time, and thus the detection frequency can be increased by shortening the detection period of the object as compared with the case where the WAIT time is provided.

### Modification Example 3

The wait control of Modification Example 1 and the threshold control of Modification Example 2 may be combined. For example, in a case where the reflection wave does not fall below the threshold even when threshold control is performed, wave transmission controller 91 may perform wait control instead of threshold control in the next and subsequent times to avoid detecting the reflection wave of the ultrasonic wave transmitted one time before as noise. Further, for example, in a case where the reflection wave is monitored as noise in the noise monitoring time even when wait control is performed, wave transmission controller 91 may perform threshold control instead of wait control in the next and subsequent times to avoid detecting the reflection wave of the ultrasonic wave transmitted one time before as noise. Note that, threshold control may be performed in addition to wait control rather than performing threshold control instead of wait control.

### Modification Example 4

In the above-described embodiment, the description has been made assuming that the frequency at which the ultrasonic wave is transmitted is the same in all distance measurement sensors 10, but this is not limitative, and the frequency may be varied according to the disposition position of distance measurement sensor 10. For example, the frequency may be made different between distance measurement sensor 10 disposed near the center of vehicle 1 and distance measurement sensor 10 disposed near the side of vehicle 1.

### Program

A program executed by the object detection apparatus in the above-described embodiment and each of the above-described modification examples is stored in a computer-readable storage medium such as a CD-ROM, CD-R, memory card, DVD, or flexible disk (FD) in an installable or executable file format and is provided.

Further, the program executed by the object detection apparatus in the above-described embodiment and each of the above-described modification examples may be stored on a computer connected to a network such as the Internet, and may be provided by allowing the program to be downloaded via the network. Further, the program executed by the object detection apparatus in the above-described embodiment and each of the above-described modification examples may be provided or distributed via a network such as the Internet. Further, the program executed by the object detection apparatus in the above-described embodiment and each of the above-described modification examples may be provided by being incorporated in advance into a ROM or the like.

The program executed by the object detection apparatus in the above-described embodiment and each of the above-described modification examples has a module configuration for implementing each of the above-described units on a computer. In actual hardware, for example, the above-described components are implemented on a computer by a CPU reading a learning program from an HDD into a RAM and executing the program.

As described above, according to the above-described embodiment and each of the above modification examples, it is possible to prevent the detection performance of an object from deteriorating.

Note that the above-described embodiments and each of the above-described modification examples are merely examples of specific embodiments for carrying out the present disclosure, and the technical scope of the present disclosure is not interpreted in a limited manner by these embodiments and modification examples. For example, the present disclosure can be implemented in various forms without departing from the spirit or essential characteristics thereof. For example, the above-described embodiment and each of the above-described modification examples may be appropriately combined with each other in each configuration unit. Further, for example, in the above-described embodiment and each of the above-described modification examples, some components may be deleted from all the components.

In the above description, the notation “ . . . part” used for each component may be replaced by other notation such as “ . . . assembly,” “ . . . circuitry,” “ . . . device,” “ . . . unit,” or “ . . . module. The object detection device may also be configured to be executed by a CPU using a program stored in a memory.

This disclosure includes the following aspects.
(1) An object detection apparatus including: a first sensor which, in operation, measures a distance to an object using an ultrasonic wave in a first period, the first sensor being configured to be provided on a vehicle; a second sensor which, in operation, measures the distance to the object using the ultrasonic wave in a second period after the first period, the second sensor being configured to be provided on the vehicle; and a controller that sets a noise monitoring period by the second sensor between the first period and the second period, and when noise is detected in the noise monitoring period, sets a next second period after a next noise monitoring period and a wait period.
(2) The object detection apparatus according to (1), in which the controller sets another noise monitoring period before the first period.
(3) The object detection apparatus according to (1), in which the wait period is longer than a time until the noise is detected in the noise monitoring period.
(4) The object detection apparatus according to any one of (1) to (3), further including a determiner that determines the same object as the object when the same object is detected a predetermined number of times by any of the first sensor and the second sensor.
(5) An object detection apparatus including: a first sensor which, in operation, measures a distance to an object using an ultrasonic wave in a first period, the first sensor being configured to be provided on a vehicle; a second sensor which, in operation, measures the distance to the object using the ultrasonic wave in a second period after the first period, the second sensor being configured to be provided on the vehicle; and a controller that sets a noise monitoring period by the second sensor between the first period and the second period, and when noise exceeding a first threshold is detected in the noise monitoring period, sets a next noise monitoring period using a second threshold between the next first period and the next second period, the second threshold being larger than the first threshold.
(6) The object detection apparatus according to (5), further including a determiner that determines the same object as the object when the same object is detected a predetermined number of times by any of the first sensor and the second sensor.
(7) A method of detecting an object including: measuring a distance to an object using an ultrasonic wave in a first period by a first sensor configured to be provided on a vehicle; performing noise monitoring using the ultrasonic wave in a noise monitoring period after the first period by a second sensor configured to be provided on the vehicle; measuring the distance to the object using the ultrasonic wave in a second period after the noise monitoring period by the second sensor; and setting, when noise is detected in the noise monitoring period, a next second period after a next noise monitoring period and a wait period.
(8) The method of detecting an object according to (7), in which another noise monitoring period is set before the first period by the first sensor.
(9) The method of detecting an object according to (7), in which the wait period is longer than a time until the noise is detected in the noise monitoring period.
(10) The method of detecting an object according to any one of (7) to (9), further including: determining, when the same object is detected a predetermined number of times by any of the first sensor and the second sensor, the same object as the object.
(11) A method of detecting an object, including: measuring a distance to an object using an ultrasonic wave in a first period by a first sensor configured to be provided on a vehicle; performing noise monitoring using the ultrasonic wave in a noise monitoring period after the first period by a second sensor configured to be provided on the vehicle; measuring the distance to the object using the ultrasonic wave in a second period after the noise monitoring period by the second sensor, and setting, when noise exceeding a first threshold is detected in the noise monitoring period, a next noise monitoring period using a second threshold between the next first period and the next second period, the second threshold being larger than the first threshold.
(12) The method of detecting an object according to (11), further including: determining, when the same object is detected a predetermined number of times by any of the first sensor and the second sensor, the same object as the object.

This application is entitled to and claims the benefit of Japanese Patent Application No. 2024-035980 filed on Mar. 8, 2024, the disclosure each of which including the specification, drawings and abstract is incorporated herein by reference in its entirety.

### REFERENCE SIGNS LIST

1 Vehicle
10, 10RL, 10RLC, 10RRC, 10RR Distance measurement sensor
12 Wave transmitter
14 Wave receiver
16 Controller
30 Imaging apparatus
40 Radar
51 G sensor
53 Steering angle sensor
55 Travel controller
57 Operator
59 Meter computer
61 Storage
70 Bus
81 CPU
83 ROM
85 RAM
87 I/F
89 Bus
90 Control apparatus
91 Wave transmission controller
93 Detection result acquirer
95 Object detector
97 Determiner
99 Drive controller
100 Object detection apparatus

1. An object detection apparatus comprising:
a first sensor which, in operation, measures a distance to an object using an ultrasonic wave in a first period, the first sensor being configured to be provided on a vehicle;
a second sensor which, in operation, measures the distance to the object using the ultrasonic wave in a second period after the first period, the second sensor being configured to be provided on the vehicle; and
a control circuitry which, in operation, sets a noise monitoring period by the second sensor between the first period and the second period, and when noise is detected in the noise monitoring period, sets a next second period after a next noise monitoring period and a wait period.

2. The object detection apparatus according to claim 1, wherein the control circuitry which, in operation, sets another noise monitoring period before the first period.

3. The object detection apparatus according to claim 1, wherein the wait period is longer than a time until the noise is detected in the noise monitoring period.

4. The object detection apparatus according to claim 1, further comprising a determination circuitry which, in operation, determines the same object as the object when the same object is detected a predetermined number of times by any of the first sensor and the second sensor.

5. An object detection apparatus comprising:
a first sensor which, in operation, measures a distance to an object using an ultrasonic wave in a first period, the first sensor being configured to be provided on a vehicle;
a second sensor which, in operation, measures the distance to the object using the ultrasonic wave in a second period after the first period, the second sensor being configured to be provided on the vehicle; and
a control circuitry which, in operation, sets a noise monitoring period by the second sensor between the first period and the second period, and when noise exceeding a first threshold is detected in the noise monitoring period, sets a next noise monitoring period using a second threshold between the next first period and the next second period, the second threshold being larger than the first threshold.

6. The object detection apparatus according to claim 5, further comprising a determination circuitry which, in operation, determines the same object as the object when the same object is detected a predetermined number of times by any of the first sensor and the second sensor.

7. A method of detecting an object comprising:
measuring a distance to an object using an ultrasonic wave in a first period by a first sensor configured to be provided on a vehicle;
performing noise monitoring using the ultrasonic wave in a noise monitoring period after the first period by a second sensor configured to be provided on the vehicle;
measuring the distance to the object using the ultrasonic wave in a second period after the noise monitoring period by the second sensor; and
setting, when noise is detected in the noise monitoring period, a next second period after a next noise monitoring period and a wait period.

8. The method of detecting an object according to claim 7, wherein another noise monitoring period is set before the first period by the first sensor.

9. The method of detecting an object according to claim 7, wherein the wait period is longer than a time until the noise is detected in the noise monitoring period.

10. The method of detecting an object according to claim 7, further comprising: determining, when the same object is detected a predetermined number of times by any of the first sensor and the second sensor, the same object as the object.

11. A method of detecting an object, comprising:
measuring a distance to an object using an ultrasonic wave in a first period by a first sensor configured to be provided on a vehicle;
performing noise monitoring using the ultrasonic wave in a noise monitoring period after the first period by a second sensor configured to be provided on the vehicle;
measuring the distance to the object using the ultrasonic wave in a second period after the noise monitoring period by the second sensor, and
setting, when noise exceeding a first threshold is detected in the noise monitoring period, a next noise monitoring period using a second threshold between the next first period and the next second period, the second threshold being larger than the first threshold.

12. The method of detecting an object according to claim 11, further comprising: determining, when the same object is detected a predetermined number of times by any of the first sensor and the second sensor, the same object as the object.
